(19) United States
(12) Patent Application Publication
(10) Pub. No.: US 2005/0253523 A1
(43) Pub. Date: Nov. 17, 2005

(54) Fluorescent lamp for backlight device

(76) Inventor: Yi-Shiuan Tsai, Kaohsiung City (TW)

Correspondence Address: David I. Roche;BAKER & McKENZIE, 130 E. Randolph Drive, Chicago, IL, 60463, US

(21) Appl. No.: 10/846,258

(22) Filed: May 14, 2004

(51) Int. Cl. H01J 61/30

(52) U.S. Cl. 313/634

(57) ABSTRACT

A fluorescent lamp structure comprises a lamp vessel confining a discharge gas, a fluorescent material located inside the lamp vessel, and at least a pair of first electrodes and a pair of second electrodes mounted to the lamp vessel, wherein the first electrodes are electrically connected to a power source to energize the discharge gas in the lamp vessel, and the second electrodes are electrically in a floating state.

### BACKGROUND OF THE INVENTION

1. Field of the Invention

The present invention generally relates to backlight devices, and more particularly to a fluorescent lamp structure suitable for a backlight device.

2. Description of the Related Art

In LCD systems, the orientation of liquid crystal molecules are electrically controlled to selectively allow the transmission of light supplied by a light source, and thereby achieve image displaying. In transmissive or transflective LCD, the light source usually includes a backlight that illuminates the LCD panel from behind, i.e. a side opposite to that of the viewer. The current state of the art knows many types of backlight devices, using diverse mechanisms of light-emitting sources such as light-emitting diodes, fluorescent lamps or the like.

FIG. 1A is a schematic view of a conventional fluorescent lamp known in the art. The conventional fluorescent lamp includes a glass lamp tube 110 in which is confined a discharge gas 112. A fluorescent layer 118 is coated on an inner surface of the lamp tube 110. Electrodes 114 are placed inside the lamp tube 110, and connect via power wires 116 to a power source.

To illuminate the fluorescent lamp, a voltage bias is applied via an inverter (not shown) to the electrodes 114. The inverter operates to convert AC or DC power to a high frequency power for driving the fluorescent lamp. The voltage bias creates a charge move across the lamp tube 110, which energize the discharge gas 112 and generates the irradiation of a wavelength that stimulates the fluorescent layer 118 for irradiating visible light.

One disadvantage of the above lamp structure is that the electrodes 114 are conventionally connected to the power wires 116 via a soldering process. This soldering process may be technically difficult, particularly in respect of the requirement of hermetic sealing for the lamp tube. Further, the solder connection may be damaged and break off. Reliability concerns therefore may be raised in this type of lamp structure.

FIG. 1B illustrates another structure of fluorescent lamp known in the art. In this lamp structure, the electrodes 120 are externally placed on the lamp tube 110, so that problems due to solder connections to the power wires are overcome. However, a much higher power voltage is required to illuminate the fluorescent lamp. This high driving power voltage requires redesigning the inverter, which increases the production cost.

Therefore, there is a need for a fluorescent lamp structure that can overcome the prior problems, and particularly for a fluorescent lamp structure that does not increase the driving power voltage and has a reliable construction.

### SUMMARY OF THE INVENTION

In some embodiment, a fluorescent lamp structure according to the invention comprises a lamp vessel confining a discharge gas, a fluorescent material located inside the lamp vessel, and at least a pair of first electrodes and a pair of second electrodes mounted to the lamp vessel, wherein the first electrodes are electrically connected to a power source to energize the discharge gas in the lamp vessel, and the second electrodes are electrically in a floating state.

In some embodiments, the second electrodes are placed inside the lamp vessel at locations respectively corresponding to the first electrodes. In other embodiments, the second electrodes are attached to an inner surface of the lamp vessel via an adhesion layer, and are in contact with the discharge gas.

In some embodiments, the first electrodes lie on a common surface of the lamp vessel. In some variant embodiments, the first electrodes lie on opposite side edge surfaces of the lamp vessel. In other embodiments, the first electrodes lie on non-opposite surfaces of the lamp vessel. In other variations, the first electrodes lie at two opposite ends of the lamp vessel, respectively oriented in opposite directions.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIGS. 1A and 1B are schematic views of fluorescent lamp structures known in the art;

FIG. 2A is a perspective view of a tubular fluorescent lamp according to an embodiment of the invention;

FIG. 2B is a cross-sectional view taken along the section 2B of FIG. 2A;

FIG. 2C is a schematic diagram of a circuit implementation of a backlight according to an embodiment of the invention;

FIGS. 2D and 2E are schematic views of a tubular fluorescent lamp according to other variant embodiments of the invention;

FIG. 3A is a perspective view of a flat fluorescent lamp according to an embodiment of the invention;

FIG. 3B is a cross-sectional view taken along the section 3B of FIG. 3A;

FIGS. 3C˜3F are schematic views of different variations of the flat fluorescent lamp shown in FIG. 3A according to the invention; and

FIGS. 4A˜4C are schematic views of a backlight device according to various embodiments of the invention.

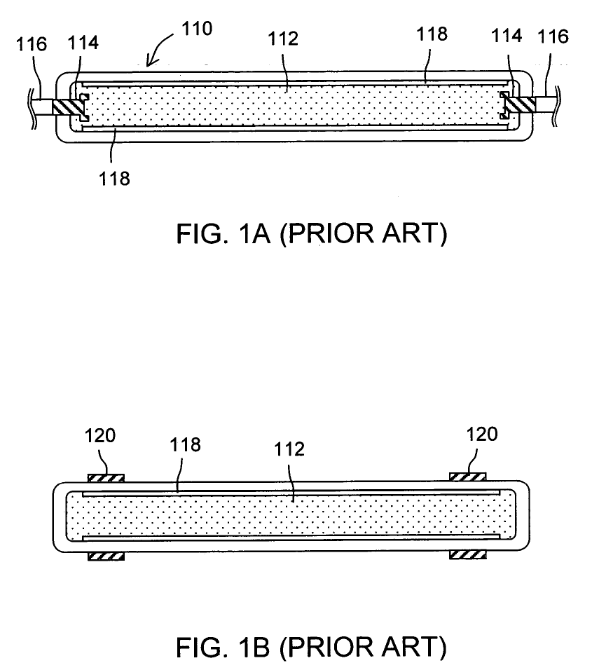

### DETAILED DESCRIPTION OF THE EMBODIMENT(S)

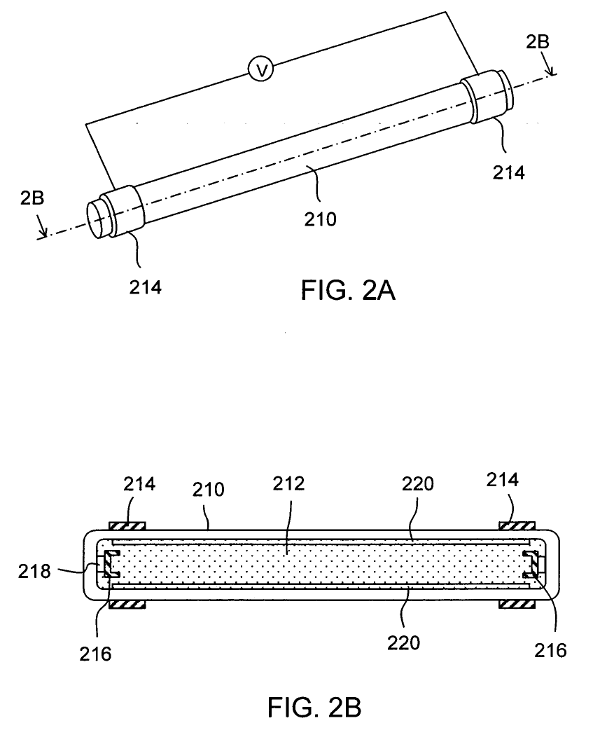

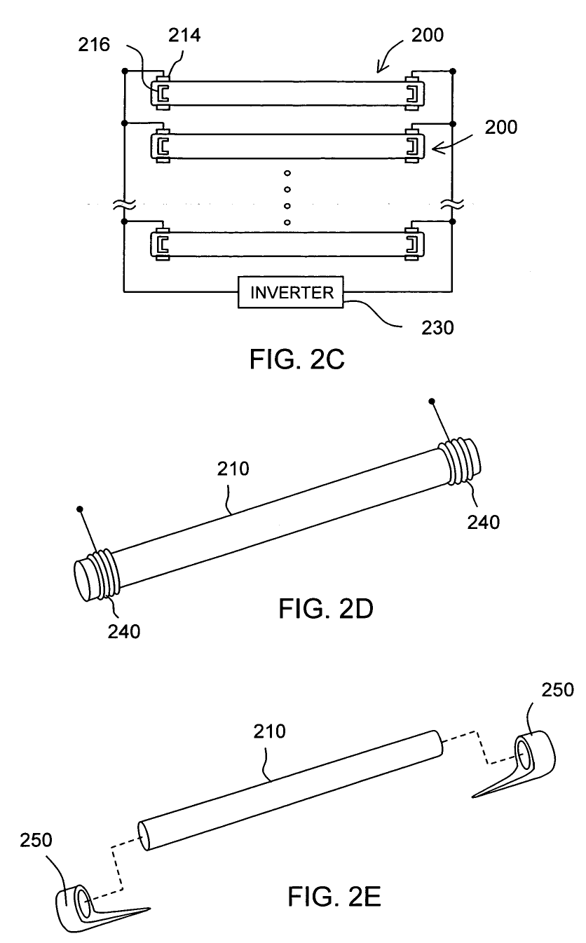

FIGS. 2A and 2B are schematic views of a fluorescent lamp structure according to an embodiment of the invention, wherein FIG. 2B is a cross-sectional view taken along section 2B in FIG. 2A. The fluorescent lamp structure 200 comprises a lamp vessel 210 having a discharge chamber in which is confined a discharge gas 212. In the illustrated embodiment, the lamp vessel 210 is a hollow cylindrical tube made of a transparent material such as glass. In an example of implementation, the discharge gas 212 can include a mixture of rare gas, mercury (Hg) vapor and argon (Ar) inert gas at a pressure between about 10 KPa to 20 KPa.

A light-emitting layer 220 is formed on an inner surface of the lamp vessel 210. The light-emitting layer 220 is made of a fluorescent material that includes a blend of phosphorous materials adequately selected according to the desired wavelength emission. For example, (SrCaBaMg)₅(PO₄)₃Cl:Eu phosphor-based material can be used for blue color emission, LaPO₄:Ce,Tb can be used for green color emission, Y₂O₃:Eu can be used for red color emission, and Ca₁₀(PO₄)₆FCl:Sb,Mn can be used for white color emission.

Energizing electrodes 214 are mounted on an outer surface and at opposite sides of the lamp vessel 210. The energizing electrodes 214 receive the application of a power voltage bias to energize the discharge gas 212. Diverse processing methods can be implemented to manufacture the electrodes 214, such as a plating process, a coating process, a vacuum process or the like. Materials suitable for forming the electrodes 214 can include transparent conductive materials such as indium tin oxide (ITO) or indium zinc oxide (IZO), or other conductive materials such as conductive metals or metallic alloys.

Floating electrodes 216 are placed in the discharge chamber. The floating electrodes 216 can be in contact with the discharge gas 212, and be located in areas corresponding to the energizing electrodes 214. The floating electrodes 216 are in an electrically floating state, i.e. they do not receive any voltage bias. Conductive materials such as metal or metal alloys can be suitable to form the floating electrodes 216. Adhesive layers 218 incorporating a dielectric material can be used to attach and isolate the floating electrodes 216 on an inner surface of the lamp vessel 210. In FIG. 2B, the floating electrodes 216 are formed in a U-shape, but any shapes can be generally suitable.

FIG. 2C is a schematic diagram of a backlight circuit implementation according to an embodiment of the invention. The backlight circuit comprises a plurality of fluorescent lamps 200 connected in parallel to an inverter 230. The fluorescent lamps 200 respectively include energizing electrodes 214 to which an electric bias is applied to illuminate the lamps 200, and inner floating electrodes 216 in contact with the discharge gas.

When a voltage bias is applied via the inverter 230 to the energizing electrodes 214, an electric discharge is created within the lamp vessel, particularly at the floating electrodes 216. The discharged electrons move across the lamp vessel and collide with the discharge gas, which dissociates into ions, electrons, and neutrons to form a plasma environment. The plasma formation generates the irradiation of an energetic wavelength (i.e. ultraviolet wavelength) that stimulates the fluorescent layer. Consequently, the fluorescent layer emits visible light for illuminating the display system.

Provided with the assembly of energizing electrodes 214 and floating electrodes 216, the fluorescent lamp in operation does not increase the power voltage bias and a single inverter design can be used to drive a plurality of fluorescent lamps.

It is understood that many variations of the fluorescent lamp can be envisaged. FIG. 2D illustrates another example where the energizing electrodes can be coils 240 wound at opposite ends of the lamp vessel 210. FIG. 2E shows a variant example where the energizing electrodes can be in the form of sleeves 250 fitting with opposite ends of the lamp vessel 210. The energizing sleeve electrodes 250 can be formed in a manner to be detachably fastened to the lamp vessel 210 by insertion, for example.

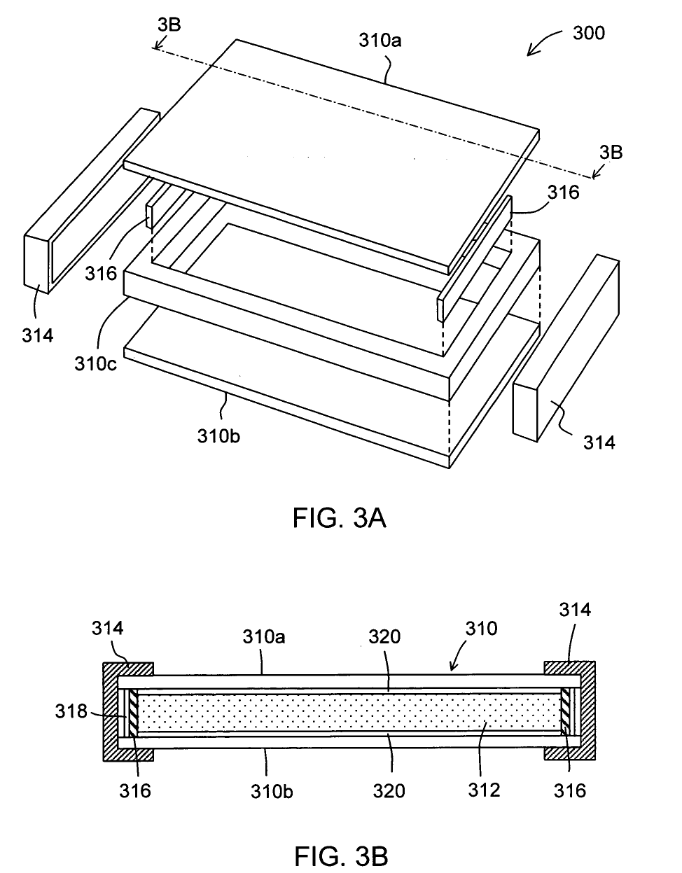

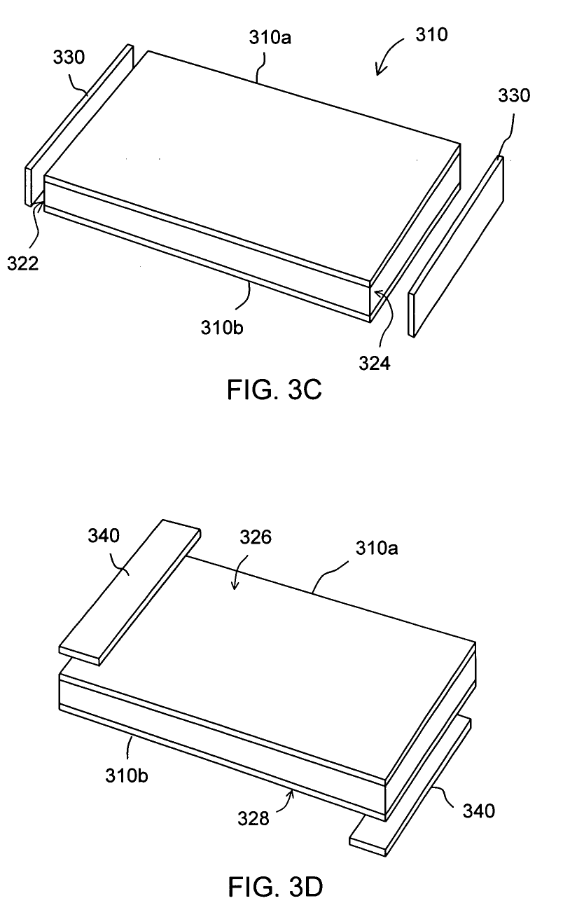

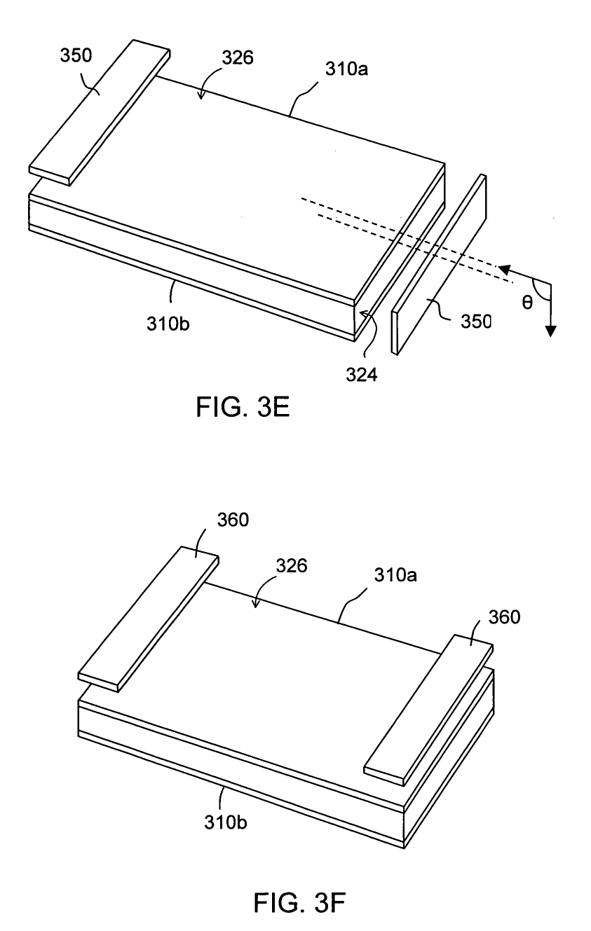

Reference now is made to FIGS. 3A and 3B to describe a variant embodiment of the invention implemented as a flat fluorescent lamp structure. The lamp structure 300 includes a lamp vessel 310, having a generally flat or planar shape. In the illustrated implementation, the lamp vessel 310 includes the assembly of upper and lower planar plates 310a, 310b respectively sealed at the top and bottom of a frame 310c. The plates 310a, 310b can be made of transparent glass materials.

As shown in FIG. 3B, the lamp vessel 310 delimits an inner chamber where is hermetically confined a discharge gas 312. The upper plate 310a and the lower plate 310b have an inner surface respectively covered with a light-emitting layer 320. The light-emitting layer 320 can be a fluorescent layer composed of a phosphorous blend.

Energizing electrodes 314 are placed at opposite sides of the lamp vessel 310. The energizing electrodes 314 can be formed as sleeves respectively fitting to two opposite ends of the lamp vessel 310. The energizing electrodes 314 are connected to a power source to energize the discharge gas and illuminate the fluorescent lamp.

Floating electrodes 316 are placed inside the lamp vessel 310 in contact with the discharge gas 312, at locations respectively corresponding to the energizing electrodes 314. The floating electrodes 316 are in an electrically floating state, i.e. no electric bias is applied thereto. Adhesive layers 318 incorporating a dielectric material can be used to attach and isolate the floating electrodes 316 on inner surfaces of the frame 310c. In FIGS. 3A and 3B, the floating electrodes 316 are exemplary planar, but it is understood that any shapes can be generally suitable.

FIGS. 3C and 3F illustrate other variant embodiments of a flat fluorescent lamp according to the invention. In these variant examples, the energizing electrodes are specifically formed in a planar or plate shape.

As shown in FIG. 3C, the energizing electrodes 330 can be placed on two opposite side edge surfaces 322, 324 of the lamp vessel 310. These side edges can correspond to the sidewalls of the upper and lower plates 310a, 310b assembled to form the lamp vessel 310, as illustrated in FIG. 3A.

As shown in FIG. 3D, the energizing electrodes 340 can be placed at two opposite ends of the lamp vessel 310 on opposite surfaces 326, 328 of the lamp vessel 310, respectively. The energizing electrodes 340 are thereby placed in a configuration in which they are oriented in opposite directions.

In FIG. 3E, the energizing electrodes 350 are positioned on non-opposite surfaces of the lamp vessel 310. One energizing electrode 350 is placed on a surface 326 parallel to the plane of the lamp vessel 310, while the other energizing electrode 350 is placed on a side edge surface 324 of the lamp vessel 310. In this configuration, the energizing electrodes 350 define an angle θ there between.

In FIG. 3F, the energizing electrodes 360 can be positioned at two opposite ends of the lamp vessel 310 on a same surface 326 of the lamp vessel 310.

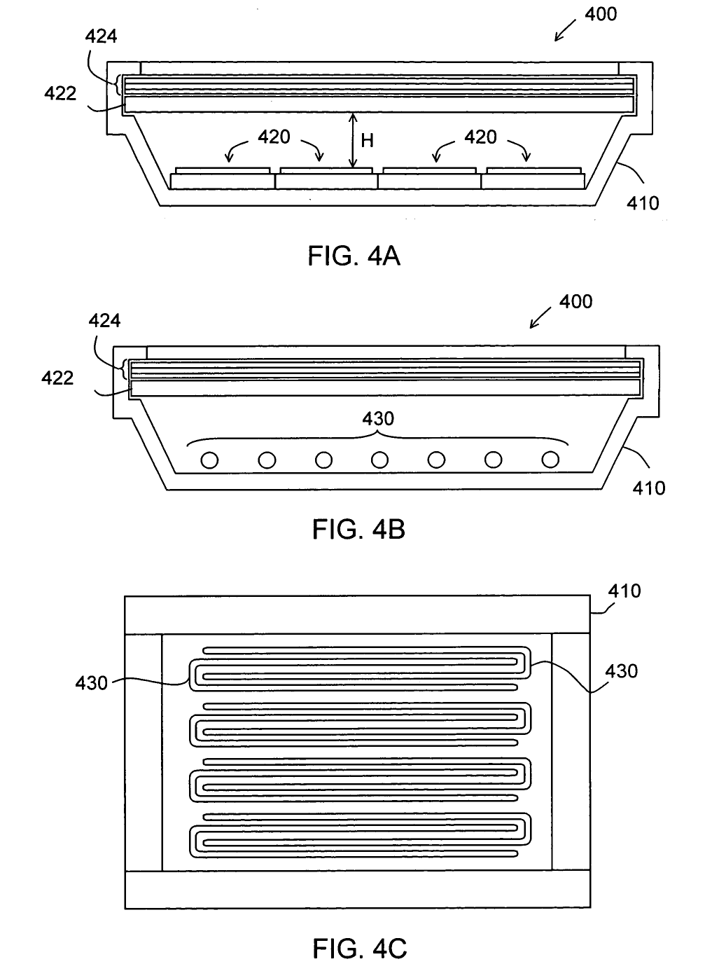

Reference now is made to FIGS. 4A˜4C to describe various implementations of a backlight device including flat fluorescent lamps according to the invention. In FIG. 4A, the backlight device can be exemplary mounted with flat fluorescent lamps. The backlight device 400 includes a frame 410 that assembles a plurality of flat fluorescent lamps 420. The flat fluorescent lamps 420 are constructed according to a design that includes the mount of floating electrodes and energizing electrodes connected to a power source. In some implementations, the flat fluorescent lamps 420 can be constructed according to any of the embodiments illustrated in FIGS. 3A˜3F. A diffusing plate 422 is mounted to the frame 410 at a distance H from the flat fluorescent lamps 420. Diffusing films 424 are mounted over the diffusing plate 422.

In the variant embodiment of FIG. 4B, tubular fluorescent lamps 430 can be mounted instead of flat fluorescent lamps. The tubular fluorescent lamps 430 are constructed according to a design that includes the mount of floating electrodes and energizing electrodes connected to a power source. In some implementations, the tubular fluorescent lamps 430 can be constructed according to any of the embodiments illustrated in FIGS. 2A˜2E. FIG. 4C shows a variant embodiment in which the tubular fluorescent lamps 430 can be exemplary formed in a U-shape.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

1. A fluorescent lamp structure, comprising:
a lamp vessel confining a discharge gas;
a fluorescent material located inside the lamp vessel; and
at least a pair of first electrodes and a pair of second electrodes mounted to the lamp vessel, wherein the first electrodes are electrically connected to a power source to energize the discharge gas in the lamp vessel, and the second electrodes are electrically in a floating state.

2. The fluorescent lamp according to claim 1, wherein the lamp vessel is in the shape of a generally cylindrical tube.

3. The fluorescent lamp according to claim 1, wherein the lamp vessel has a generally planar shape.

4. The fluorescent lamp according to claim 1, wherein the second electrodes are placed inside the lamp vessel at locations respectively corresponding to the first electrodes.

5. The fluorescent lamp according to claim 1, wherein the second electrodes are attached to an inner surface of the lamp vessel via an adhesion layer, and are in contact with the discharge gas.

6. The fluorescent lamp according to claim 1, wherein the first electrodes are conductive coils wound around opposite end portions of the lamp vessel.

7. The fluorescent lamp according to claim 1, wherein the first electrodes include conductive sleeves fitting to opposite end portions of the lamp vessel.

8. The fluorescent lamp according to claim 1, wherein the first electrode includes plate electrodes.

9. The fluorescent lamp according to claim 1, wherein the first electrodes lie on a common surface of the lamp vessel.

10. The fluorescent lamp according to claim 1, wherein the first electrodes lie on opposite side edge surfaces of the lamp vessel.

11. The fluorescent lamp according to claim 1, wherein the first electrodes lie at two opposite ends of the lamp vessel, respectively oriented in opposite directions.

12. A backlight device comprising:
a frame;
one or more fluorescent lamp assembled in the frame, wherein at least one fluorescent lamp includes:
a lamp vessel enclosing a discharge gas and a fluorescent material therein; and
at least a pair of first electrodes and a pair of second electrodes, wherein the first electrodes are electrically connected to a power source to energize the discharge gas and the second electrodes are electrically in a floating state; and
one or more light-diffusing element mounted to the frame and facing the one or more fluorescent lamp.

13. The backlight device according to claim 12, wherein the one or more fluorescent lamp includes a lamp vessel formed in a substantially planar shape.

14. The backlight device according to claim 12, wherein the one or more fluorescent lamp includes a lamp vessel formed in a tubular shape.

15. The backlight device according to claim 12, wherein the second electrodes are placed inside the lamp vessel at locations respectively corresponding to the first electrodes.

16. The backlight device according to claim 12, wherein the second electrodes are attached to an inner surface of the lamp vessel via an adhesion layer, and are in contact with the discharge gas.

17. The backlight device according to claim 12, wherein the first electrodes include plate electrodes.

18. The backlight device according to claim 12, wherein the first electrodes include conductive sleeves fitting to opposite end portions of the lamp vessel.

19. The backlight device according to claim 12, wherein the first electrodes lie on opposite side edge surfaces of the lamp vessel.

20. The backlight device according to claim 12, wherein the first electrodes lie at two opposite ends of the lamp vessel, respectively oriented in opposite directions.
